(19) United States
(12) Patent Application Publication
(10) Pub. No.: US 2019/0051188 A1
(43) Pub. Date: Feb. 14, 2019

(54) TECHNOLOGIES FOR ON-DEMAND AD HOC COOPERATION FOR AUTONOMOUS VEHICLES IN EMERGENCY SITUATIONS

(71) Applicant: Intel Corporation, Santa Clara, CA (US)

(72) Inventors: Hassnaa Moustafa, Portland, OR (US); Annie Foong, Aloha, OR (US); Johanna Swan, Scottsdale, AZ (US); Karla Saur, Portland, OR (US); Nadine Dabby, Palo Alto, CA (US)

(21) Appl. No.: 16/144,133

(22) Filed: Sep. 27, 2018

(51) Int. Cl. G08G 1/00; G05D 1/00; G05D 1/02; H04W 4/46; H04W 76/14; H04W 84/18

(52) U.S. Cl. CPC G08G 1/22; G05D 1/0055; G05D 1/0291; G05D 2201/0213; H04W 4/46; H04W 76/14; H04W 84/18; G05D 1/0088

(57) ABSTRACT

Techniques are disclosed herein for on-demand ad hoc cooperation for autonomous vehicles in an emergency situation. According to an embodiment, a trigger indicative of an emergency situation is detected by a vehicle control system. In response to the trigger, a platoon is formed with one or more vehicles within a predefined radius of the vehicle control system. Communications are established with the vehicles in the platoon to determine a course of action to perform during the emergency situation.

### BACKGROUND

An autonomous vehicle is a vehicle that is capable of sensing a surrounding environment and navigating through the environment to reach a predetermined destination, typically without further input from a vehicle operator. To do so, the autonomous vehicle includes various sensors, such as lasers, radar, global positioning system (GPS), and computer vision technologies. A vehicle control system configured with the autonomous vehicle may process sensor data to identify appropriate navigation paths, obstacles, and relevant signage.

To ensure safety and efficient traffic management in the surrounding environment, autonomous vehicles collaborate with one another using a variety of communication techniques, such as vehicle-to-vehicle (V2V) communications to transmit messages to one another over a communications channel (e.g., a 5G or dedicated short-range communications (DSRC) channel). In the event of an emergency situation (e.g., inclement weather, sensor malfunctioning in a nearby autonomous vehicle, and the like), the chance of onboard sensor failure increases, and as a result can hinder cooperation with and performance of other autonomous vehicles in proximity.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of an example computing environment in which autonomous vehicles form a platoon in response to detecting an emergency situation;

FIG. 2 is a simplified block diagram of at least one embodiment of an example vehicle control system described relative to FIG. 1;

FIG. 3 is a simplified block diagram of at least one embodiment of an environment that may be established by the vehicle control system of FIG. 1;

FIG. 4 is a simplified conceptual diagram of at least one embodiment of communications between autonomous vehicles in an emergency situation;

FIG. 5 is a simplified flow diagram of at least one embodiment of a method for forming, by one or more autonomous vehicles, a platoon in an emergency situation; and

FIG. 6 is a simplified flow diagram of at least one embodiment of a method for determining a course of action to take by a platoon of vehicles during an emergency situation.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

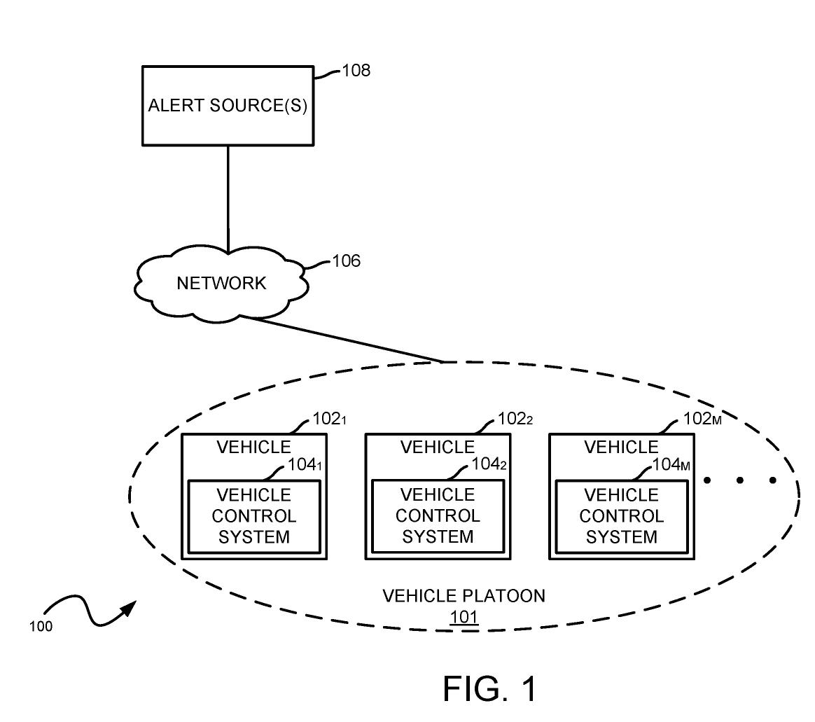

Referring now to FIG. 1, a computing environment 100 in which autonomous vehicles (e.g., vehicles 102_{1-M}) form a platoon or group (e.g., vehicle platoon 101) in response to detecting an emergency situation, e.g., while the vehicles 102_{1-M} are in operation over a given road segment. In the illustrative embodiment, the vehicles 102_{1-M} may be embodied as any type of autonomous or “driver-less” vehicle capable of transporting passengers. Further, in the embodiments described herein, the vehicles 102_{1-M} need not be fully autonomous, as one of skill in the art will recognize that the techniques of the present disclosure may also be adapted to partially autonomous vehicles.

As shown, each of the vehicles 102_{1-M} include a respective vehicle control system 104_{1-M}. The vehicle control system 104 provides decision-making and control logic to cause the vehicle to operate in an autonomous manner with little to no input from a human operator. For example, a given vehicle control system 104 may obtain data from a variety of sensors within a vehicle 102 to determine a visible road geometry, objects (e.g., road signage, traffic posts, pedestrians, other vehicles, etc.) in view of one or more of the sensors, distance from such objects, and so on. Based, in part, on the obtained sensor data, the vehicle control system 104 may determine actions to perform in operation, such as whether to maintain, increase, or reduce speed, change lanes, stop the vehicle, and so on.

Further, in an embodiment, the vehicle control system 104 may communicate with other vehicles within a radius of a given road segment, e.g., over a vehicular communications systems network. Such communications may include, for example, vehicle-to-vehicle (V2V) messages over a given frequency. The communications between vehicles may include safety warnings and traffic information to prevent accidents and traffic congestion. For example, assume that vehicle 102₁ is driving in front of vehicle 102₂ at a given road segment. In such a case, the vehicle control system 104₁ may transmit data from its sensors regarding objects observed that are not necessarily observable from the point of view of sensors of the vehicle control system 104₂, such as road signs, debris, etc.

In some cases, emergency situations may impact performance of one or more of the vehicles 102_{1-M}. For example, adverse weather conditions such as extreme fog or a sandstorm may affect the reliability of camera sensors in one of the vehicles 102. As another example, one or more of the sensors in a vehicle 102 may malfunction, impeding operation and communications of the vehicle and potentially endangering the safety of other vehicles on the road segment. Other examples of emergency scenarios include other weather conditions, sudden road collapses (e.g., sinkholes, bridge collapses, etc.), etc.

As further described, embodiments disclosed herein provide techniques for ad hoc cooperation between vehicles during an emergency situation. In an embodiment, a vehicle control system 104 may detect a trigger indicative of an emergency situation. For example, the trigger may be the vehicle control system 104 receiving a notification from one or more alert source(s) 108. An alert source 108 can include a public safety system that pushes alerts to vehicle control systems 104_{1-M} over a network 106 (e.g., a wide area network, vehicular communications systems network, the Internet, etc.). As another example, the trigger for a given vehicle can be a malfunction in one or more of the sensors of the vehicle control system 104 of the vehicle 102 itself or another nearby vehicle 102. Once detected, the vehicles 102, via the respective vehicle control systems 104, may form a platoon or group 101 with one another. The platoon 101 is indicative of a grouping of vehicles 102 within a predefined radius of a road segment. In some embodiments, the platoon 101 may be formed using a consensus protocol or other protocols as further described herein. Advantageously, such protocols may define the election of a leader to determine a course of action for each vehicle in the platoon 100 to pursue, e.g., reduce speed to a specified value, drive to the shoulder lane and come to a complete stop, etc. The leader vehicle may communicate the course of action via a standardized messaging scheme that is further described herein. Doing so allows vehicles that may have dissimilar or proprietary communications mechanisms to communicate with vehicles that may not have such mechanisms.

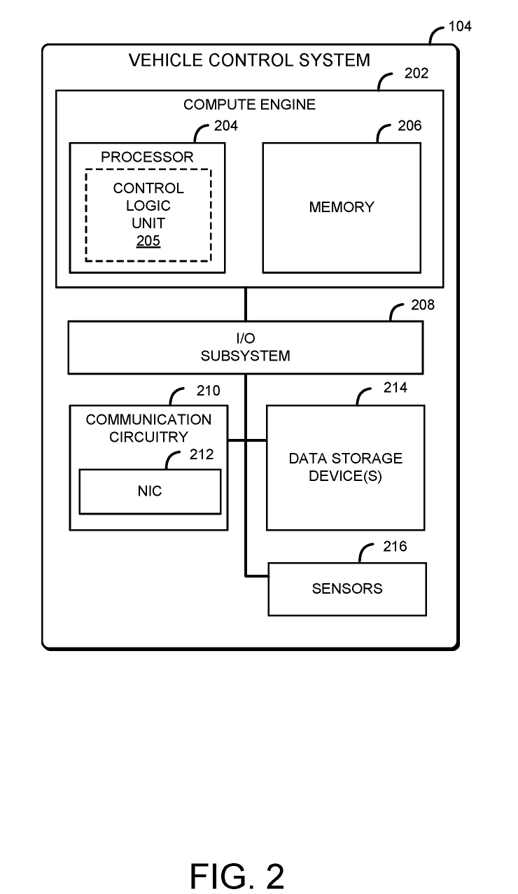

Referring now to FIG. 2, each vehicle control system 104 may be embodied as any type of device performing the functions described herein, such as detecting a trigger indicative of an emergency situation, forming a platoon with one or more vehicles within a predefined radius and direction relative to the vehicle control system 104, and establishing communications with the one or more vehicles in the platoon to determine a course of action to perform during the emergency situation.

As shown, the illustrative vehicle control system 104 includes a compute engine 202, an input/output (I/O) subsystem 208, communication circuitry 210, data storage devices 214, and sensors 216. Of course, in other embodiments, the vehicle control system 104 may include other or additional components, such as those commonly found in a computer (e.g., display, peripheral devices, etc.). Additionally, in some embodiments, one or more of the illustrative components may be incorporated in, or otherwise form a portion of, another component.

The compute engine 202 may be embodied as any type of device or collection of devices capable of performing various compute functions described below. In some embodiments, the compute engine 202 may be embodied as a single device such as an integrated circuit, an embedded system, a field programmable gate array (FPGA), a system-on-a-chip (SOC), or other integrated system or device. Additionally, in some embodiments, the compute engine 202 includes or is embodied as a processor 204 and a memory 206. The processor 204 may be embodied as one or more processors, each processor being a type capable of performing the functions described herein. For example, the processor 204 may be embodied as a single or multi-core processor(s), a microcontroller, or other processor or processing/controlling circuit. In some embodiments, the processor 204 may be embodied as, include, or be coupled to an FPGA, an ASIC, reconfigurable hardware or hardware circuitry, or other specialized hardware to facilitate performance of the functions described herein.

In the illustrative embodiment, the processor 204 includes a control logic unit 205 and a platform logic unit 207. The control logic unit 205 may be embodied as any type of hardware (e.g., a co-processor, an integrated circuit, etc.) or software used to determine and carry out courses of action for an underlying vehicle 102 (e.g., on which the vehicle control system 104 is configured), e.g., as part of a platoon formed in response to detecting an emergency situation. The control logic unit 205 may communicate with one or more of the sensors 216 via the I/O subsystem 208 to retrieve data regarding operation of the underlying vehicle 102. Further, the platform logic unit 207 may be embodied as any type of hardware (e.g., a co-processor, an integrated circuit, etc.) or software that provides autonomous functions for the vehicle 102, such as artificial intelligence (AI) and machine learning logic, to observe and learn driving situations in real-time and decide on actions as a result of the observed situations. The platform logic unit 207 may be in communication with the control logic unit 205 to trigger alert and control a driving behavior of the vehicle 102.

The memory 206 may be embodied as any type of volatile (e.g., dynamic random access memory, etc.) or non-volatile memory (e.g., byte addressable memory) or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM). In particular embodiments, DRAM of a memory component may comply with a standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces.

In one embodiment, the memory device is a block addressable memory device, such as those based on NAND or NOR technologies. A memory device may also include a three dimensional crosspoint memory device (e.g., Intel 3D XPoint™ memory), or other byte addressable write-in-place nonvolatile memory devices. In one embodiment, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. The memory device may refer to the die itself and/or to a packaged memory product. In some embodiments, 3D crosspoint memory (e.g., Intel 3D XPoint™ memory) may comprise a transistor-less stackable cross point architecture in which memory cells sit at the intersection of word lines and bit lines and are individually addressable and in which bit storage is based on a change in bulk resistance. In some embodiments, all or a portion of the memory 206 may be integrated into the processor 204.

The compute engine 202 is communicatively coupled with other components of the vehicle control system 104 via the I/O subsystem 208, which may be embodied as circuitry and/or components to facilitate input/output operations with the compute engine 202 (e.g., with the processor 204 and/or the memory 206) and other components of the vehicle control system 104. For example, the I/O subsystem 208 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 208 may form a portion of a system-on-a-chip (SoC) and be incorporated, along with one or more of the processor 204, the memory 206, and other components of the vehicle control system 104, into the compute engine 202.

The communication circuitry 210 may be embodied as any communication circuit, device, or collection thereof, capable of enabling communications over a network between the vehicle control system 104 and other devices (e.g., vehicle control systems 104 in other vehicles 102). The communication circuitry 210 may be configured to use any one or more communication technology (e.g., wired, wireless, and/or cellular communications) and associated protocols (e.g., Ethernet, Bluetooth®, Wi-Fi®, WiMAX, 5G-based protocols, etc.) to effect such communication.

The illustrative communication circuitry 210 includes a network interface controller (NIC) 212, which may also be referred to as a host fabric interface (HFI). The NIC 212 may be embodied as one or more add-in-boards, daughtercards, controller chips, chipsets, or other devices that may be used by the vehicle control system 104 for network communications with remote devices. For example, the NIC 212 may be embodied as an expansion card coupled to the I/O subsystem 208 over an expansion bus such as PCI Express.

The one or more illustrative data storage devices 214 may be embodied as any type of devices configured for short-term or long-term storage of data such as, for example, memory devices and circuits, memory cards, hard disk drives (HDDs), solid-state drives (SSDs), or other data storage devices. Each data storage device 214 may include a system partition that stores data and firmware code for the data storage device 214. Each data storage device 214 may also include an operating system partition that stores data files and executables for an operating system.

The one or more illustrative sensors 216 may be embodied as any type of devices configured to provide data regarding the surroundings or interior of the associated vehicle 102 so that logic in the vehicle control system 104 (e.g., the control logic unit 205) may carry out actions responsive to the data (e.g., whether to accelerate the vehicle 102 or come to a stop). For example, the sensors 216 can include a global positioning system (GPS), cameras, radar, lasers, speedometers, angular rate sensors, computer vision sensors, and so on. The sensors 216 may communicate data to the control logic unit 205 (or any other component within the vehicle control system 104) via the I/O subsystem 208.

Additionally or alternatively, the vehicle control system 104 may include one or more peripheral devices. Such peripheral devices may include any type of peripheral device commonly found in a compute device such as a display, speakers, a mouse, a keyboard, and/or other input/output devices, interface devices, and/or other peripheral devices.

Further, as described above, the vehicle control system 104 is illustratively in communication via the network 106, which may be embodied as any type of wired or wireless communication network, including global networks (e.g., the Internet), local area networks (LANs) (e.g., DSRC based on the Institute of Electrical and Electronics Engineers (IEEE) 802.11 specification) or wide area networks (WANs), cellular networks (e.g., Global System for Mobile Communications (GSM), 3G, Long Term Evolution (LTE), Worldwide Interoperability for Microwave Access (WiMAX), etc.), digital subscriber line (DSL) networks, cable networks (e.g., coaxial networks, fiber networks, etc.), or any combination thereof.

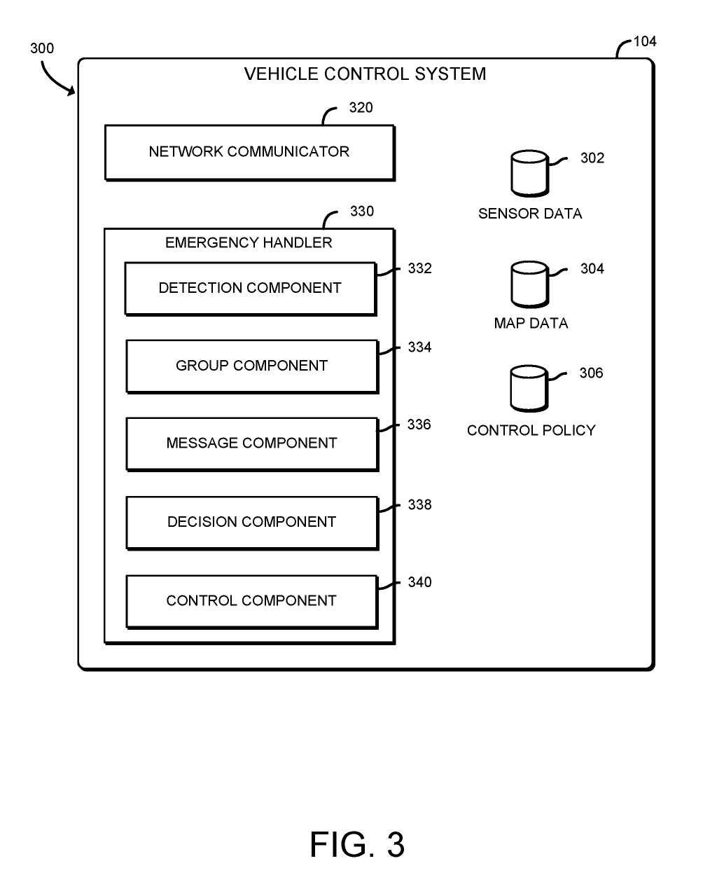

Referring now to FIG. 3, a vehicle control system 104 may establish an environment 300 in operation. The illustrative environment 300 includes an autonomous driving platform 310, a network communicator 320, and an emergency handler 330. Each of the components of the environment 300 may be embodied as hardware, firmware, software, or a combination thereof. Further, in some embodiments, one or more of the components of the environment 300 may be embodied as circuitry or a collection of electrical devices (e.g., autonomous driving platform circuitry 310, network communicator circuitry 320, emergency handler circuitry 330, etc.). It should be appreciated that, in such embodiments, one or more of the autonomous driving platform circuitry 310, network communicator circuitry 320, and emergency handler circuitry 330 may form a portion of one or more of the NIC 212, compute engine 202, the communication circuitry 210, the I/O subsystem 208, data storage devices 214, sensors 216, and/or other components of the vehicle control system 104.

In the illustrative embodiment, the environment 300 includes sensor data 302, which may be embodied as any data captured by the sensors in the vehicle control system 104 (or the underlying vehicle 102 generally). For example, the sensor data 302 may include geolocation data, visible road geometry data, image sensor data, speedometer data, data from laser and radar sensors, and the like. Further, the environment 300 also includes map data 304, which may be embodied as any data representative of information of paths and traffic information for one or more geolocations. The map data 304 may be routinely updated by a remote server, by the vehicle control system 104 after obtaining up-to-date sensor data (e.g., from the on-board sensors or from sensor updates sent by other vehicles 102). Further still, the environment 300 includes a control policy 306, which may be embodied as any data providing rules and conditions for determining a course of action, e.g., regarding an emergency situation. For instance, the control policy 306 may specify certain actions to take in response to detecting sensor data to satisfy certain criteria (e.g., values exceeding thresholds, road conditions being observed by the sensors, etc.). The control policy 306 may also specify rules for how a platoon is to be formed in an emergency situation. For instance, the control policy 306 may specify to determine a leader in the platoon based on operational sensors in each vehicle. In such a case, the control policy 306 may also specify weights to be attributed to each operational sensor to allow each vehicle to rank one another for determining the leader of the platoon. The control policy 306 may also specify conditions in which a platoon should be dissolved (e.g., cessation of movement in all vehicles in the platoon, operator override, sensors in all vehicles of the platoon becoming operational for a period of time exceeding a threshold, etc.).

The autonomous driving platform 310, which may be embodied as hardware, firmware, software, virtualized hardware, emulated architecture, and/or a combination thereof as discussed above, is configured to observe and learn driving situations, e.g., using a variety of AI and machine learning techniques. For example, the autonomous driving platform 310 is configured to distinguish between normal and abnormal driving behavior based on observed conditions in operation. Doing so allows the autonomous driving platform 310 to pursue a given course of action based on whether observed driving behavior is identified to be abnormal. The autonomous driving platform 310 may be in communication with the emergency handler 330 to carry out control decisions in the event of an emergency situation occurring during operation of the vehicle 102.

The network communicator 320, which may be embodied as hardware, firmware, software, virtualized hardware, emulated architecture, and/or a combination thereof as discussed above, is configured to facilitate inbound and outbound network communications (e.g., network traffic, network packets, network flows, etc.) to and from other devices, such as from alert sources (e.g., remote centralized servers sending public safety updates to vehicles 102, other vehicles 102, etc.) and vehicle control systems 104 in other vehicles 102. To do so, the network communicator 320 is configured to receive and process data packets from one system or computing device (e.g., other vehicle control systems 104, etc.) and to prepare and send data packets to another computing device or system. Accordingly, in some embodiments, at least a portion of the functionality of the network communicator 320 may be performed by the communication circuitry 210, and, in the illustrative embodiment, by the NIC 212.

The illustrative emergency handler 330, which may be embodied as hardware, firmware, software, virtualized hardware, emulated architecture, and/or a combination thereof as discussed above, is configured to detect a trigger indicative of an emergency situation, form a platoon with one or more vehicles within a predefined radius, and establish, via a standardized protocol, communications with the vehicles in the platoon. Further, the emergency handler 330 is also to determine a course of action as a function of the emergency situation and platoon vehicle data, send the course of action and sensor data to the vehicles in the platoon, retrieve sensor data and visible road geometry from the vehicles, and direct vehicles to carry out the course of action. In an embodiment, the emergency handler 330 includes a detection component 332, a group component 334, a message component 336, a decision component 338, and a control component 340.

The detection component 332 is configured to process triggers indicative of an emergency situation that may impact the vehicle 102. For example, an alert source, such as a remote server that transmits updates to the vehicle control system 104 may notify the vehicle control system 104 of an adverse weather event in the area, such as flooding. The detection component 332 may correlate the information with an area in which the vehicle is currently present and determine whether the vehicle is in an emergency situation. Another trigger may include a nearby vehicle 102, such as a vehicle 102 that is within a predefined radius of a road segment shared with the underlying vehicle 102 associated with the vehicle control system 104, may send a notification to the detection component 332 of a sensor malfunction or some other emergency situation (e.g., a road collapse that was observed by the vehicle 102). Alternatively (or additionally), that vehicle 102 may send a notification to the aforementioned remote server regarding the emergency. In turn, the remote server may transmit the notification to the detection component 332. Yet another trigger may include the detection component 332 identifying a malfunction in one or more of the on-board sensors. For example, in an adverse weather event, such as a sandstorm, camera sensors may eventually fail due to the lack of visibility.

The group component 334 is configured to, in response to detection of a trigger by the detection component 332, form a platoon with vehicles in the given area that may be impacted by the emergency situation associated with the trigger. The group component 334 may form the platoon, e.g., using ad hoc network forming techniques, on-demand group forming techniques, and the like, with other vehicles 102 in proximity. The group component 334 may also determine which vehicles to include based on a direction in which the other vehicles are moving (e.g., to ensure that vehicles moving in the opposite direction are not included with the platoon).

Further, the group component 334 is configured to determine, with other vehicles 102 in the platoon, a leader vehicle in the platoon. The leader vehicle sets actions to be carried out by the vehicles in the platoon, e.g., to prevent vehicles 102 in the platoon from colliding with one another. For example, in a sandstorm, the leader vehicle may evaluate a control policy (e.g., control policy 306) to determine to continue driving at a reduced pace (e.g., at 20 miles per hour) until the vehicles 102 are in a suitable area to stop. The group component 334 (and other vehicles) may use an agreed-upon protocol to determine the leader. For example, the group component 334 may use a distributed consensus technique, a leader election in quorum-based voting (e.g., via a commit protocol), and the like. Further, the group component 334 may evaluate operational sensors of each vehicle (communicated by the other vehicles 102), in determining the leader vehicle.

The message component 336 is to generate, send, and receive messages to/from other vehicles 102 in the platoon. In an emergency situation, the message component 336 may override configured messaging protocols to a standardized messaging protocol. Doing so allows vehicles 102 of differing messaging protocols to communicate with one another. An example standardized messaging protocol may be based on the publish-subscribe model, such as MQTT (Message Queuing Telemetry Transport). A payload of a message sent by the message component 336 can be in a format that can be parsed by any vehicle 102 and descriptive enough for the vehicle 102 to reconstruct road geometry from the message. For instance, the message may be of a JavaScript Object Notation (JSON) or a text format.

The message component 336 may subscribe to a messaging service provided by each vehicle 102. Doing so allows the message component 336 to receive messages published by the other vehicles. The messages may contain information used to assist each vehicle in handling the emergency situation. For instance, a message may include sensor data and visible road geometry information for a given time period. The message can contain a map of the field of view positioning the vehicle 102 from other visible vehicles 102 in proximity. Further, a message may include information regarding a course of action to take based on an aggregate of sensor data and visible road geometry information of the vehicles in the platoon. Further still, a message may include decision information, such as a vote to establish a quorum, regarding whether to carry out the course of action.

The decision component 338 may generate a course of action as a function of the emergency situation and information provided by the other vehicles in the platoon. For example, the decision component 338 in a leader vehicle may evaluate the information provided by the other vehicles relative to the emergency situation and the control policy 306 to determine a course of action to carry out. In non-leader vehicles, the decision component 338 may receive the course of action and vote (e.g., based on an evaluation of on-board sensor data 302 and on a control policy 306) whether to carry out the course of action. The decision component 338 may transmit the decision to the message component 336 for sending to the other vehicles. In a leader vehicles, the decision component 338 may receive the results of voting for a given course of action and determines whether to carry out the course of action based on the voting. For instance, if a quorum (e.g., a specified amount) of votes is obtained, then the decision component 338 may determine to carry out the course of action. Otherwise, if not, the decision component 338 may determine another course of action given additional data, such as additional sensor data from the other vehicles in the platoon.

The control component 340 may direct the underlying vehicle to carry out a course of action agreed-upon by a given amount of vehicles (e.g., a quorum of the vehicles) in the platoon. For example, the control component 340 may communicate with vehicle hardware to, e.g., control acceleration, braking, steering, and the like, in the vehicle.

It should be appreciated that each of the network communicator 320 and components in the emergency handler 330 may be separately embodied as hardware, firmware, software, virtualized hardware, emulated architecture, and/or a combination thereof. For example, the network communicator 320, detection component 332, and group component 334 may be embodied as hardware components, while the message component 336, decision component 338, and control component 340 are embodied as virtualized hardware components or as some other combination of hardware, firmware, software, virtualized hardware, emulated architecture, and/or a combination thereof.

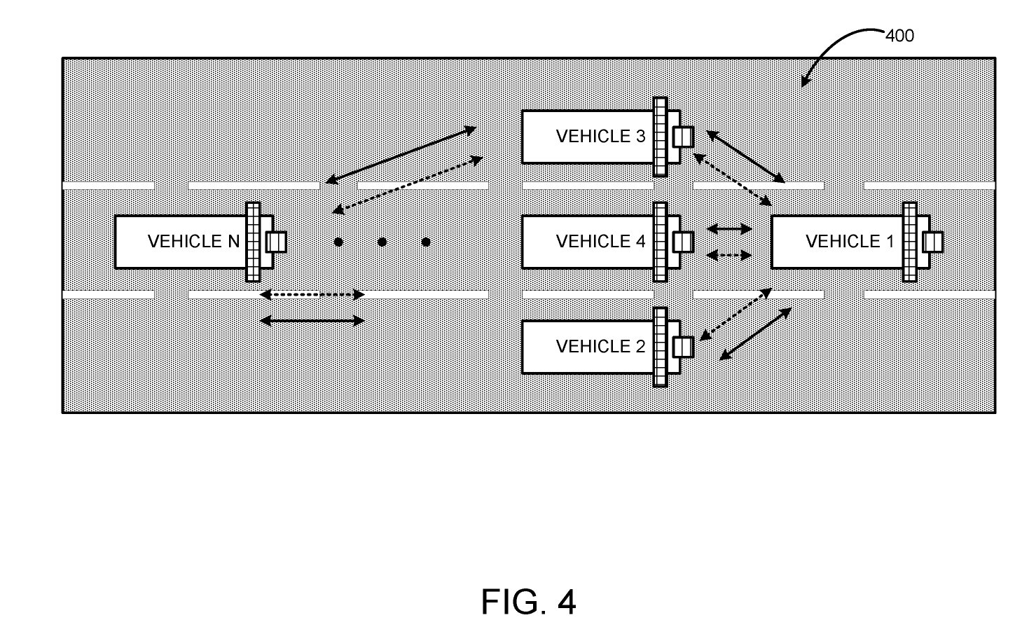

Referring now to FIG. 4, a simplified conceptual diagram of a platoon 400 on a three-lane road segment is shown. For this example, assume that the platoon 400 was formed in response to an emergency situation, such as a sandstorm affecting the road segment. Illustratively, the platoon 400 includes vehicles 1-N. The positioning of the vehicles 1-N relative to one another may be determined during the formation process. For instance, the vehicle control system 104 of the leader vehicle may determine the formation based on a weighting and ranking of operational sensors in each vehicle (e.g., in which vehicles having more operational sensors are positioned further in front of the platoon 400).

The two-way arrows to and from a given vehicle in the platoon 400 is representative of communications between the vehicle and another vehicle using the standardized messaging system. In this example, the solid two-way arrow represents the vehicles sharing sensor data (e.g., data observed from camera sensors, road sensors, radars, lasers, and the like). The dashed two-way arrow represents decisions (e.g., voting) on a given course of action by the vehicle. For example, a course of action could include driving at a reduced speed (e.g., 10 miles per hour) until the sensors of the leader vehicle identify a suitable area to stop. Each vehicle may send the voting information across vehicles in the platoon and may share the voting information of other vehicles.

Illustratively, two rectangles—a solid black rectangle and a horizontal line patterned rectangle, are shown on each vehicle. The smaller and horizontal line patterned rectangle represents information observed via on-board sensors by a given vehicle. As stated, the vehicle may transmit this data to other vehicles 1-N using the standardized messaging system. The longer and solid black rectangle on a given vehicle represents aggregated sensor data. The aggregated sensor data may include correlated information using the shared sensor data of other vehicles. For example, if a given vehicle has limited camera sensor operability in the emergency situation (e.g., due to a malfunction in the camera sensor due to the sand), the vehicle control system in that vehicle may determine, based on sensor data shared by other vehicles 1-N (e.g., the vehicles 1-N positioned in front of the given vehicle), then the vehicle may construct a visual representation of the road segment from the shared data.

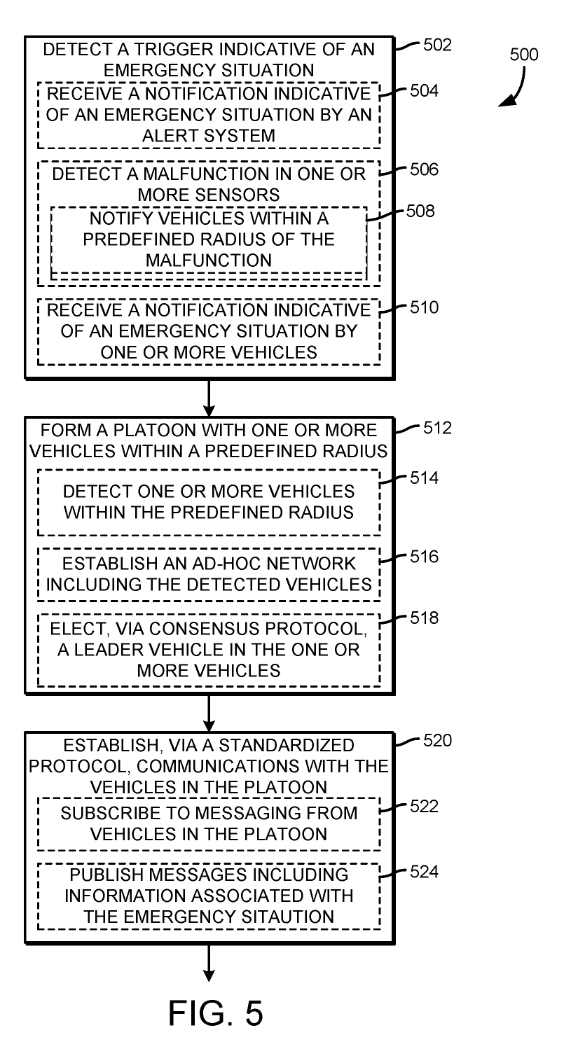

Referring now to FIG. 5, a vehicle control system 104, in operation, may perform a method 500 for forming a platoon or group in response to detecting an emergency situation over a road segment. As shown, the method 500 begins in block 502, in which the vehicle control system 104 detects a trigger indicative of an emergency situation. For instance, in block 504, the vehicle control system 104 receives a notification indicative of an emergency situation by an alert system, e.g., a remote server that sends safety notifications to autonomous vehicles in operation. As another example, in block 506, the vehicle control system 506 detects a malfunction in one or more sensors. The malfunction may be a result of an operational failure or due to factors relating to the emergency situation (e.g., weather affecting the normal operation of the sensors). In such a case, in block 508, the vehicle control system 104 notifies about the malfunction to vehicles in a predefined radius. Further, the vehicle control system 104 may also notify the malfunction to the alert system. The notification may include a geolocation of the vehicle as well as other information, such as which sensors have malfunctioned, an identifier associated with the vehicle, and the like. As yet another example, in block 510, the vehicle control system 104 receives a notification indicative of an emergency situation by one or more vehicles, e.g., using a V2V communication message. For instance, another vehicle may notify the vehicle control system 104 of a malfunction in a sensor.

In block 512, the vehicle control system 104 forms a platoon with one or more vehicles in a predefined radius. In particular, in block 514, the vehicle control system 104 may detect one or more vehicles within a predefined radius of the vehicle control system 104 for a current road segment (e.g., within a one mile radius). Further, the vehicle control system 104 may also filter autonomous vehicles that are heading in another direction from the platoon (e.g., vehicles moving in the opposite direction, vehicles moving in a perpendicular direction, etc.). In block 516, the vehicle control system 104 establishes an ad hoc network with the other vehicles, e.g., using ad hoc network forming techniques with the vehicle control systems 104 for the other vehicles. Further, in block 518, the vehicle control system 104 may perform a consensus protocol to elect a leader vehicle from the vehicles in the platoon. As stated, the consensus protocol may also factor in parameters associated with each vehicle, such as operational sensor data.

In block 520, the vehicle control system 104 establishes, via a standardized protocol, communications with the vehicles in the platoon. In particular, in block 522, the vehicle control system 104 subscribes to a messaging service of other vehicles in the platoon. The messaging service may be based on, e.g., a MQTT protocol. In block 524, the vehicle control system 104 publishes messages including information associated with the emergency situation. For instance, the information may include data observed from the on-board sensors of the vehicle, messages received from other vehicles (allowing vehicles communicative with the vehicle control system 104 but not with one or other vehicles in the platoon to retrieve those alerts), messages received from the alert system, and the like. The information can also include course of action and decision voting from the vehicles.

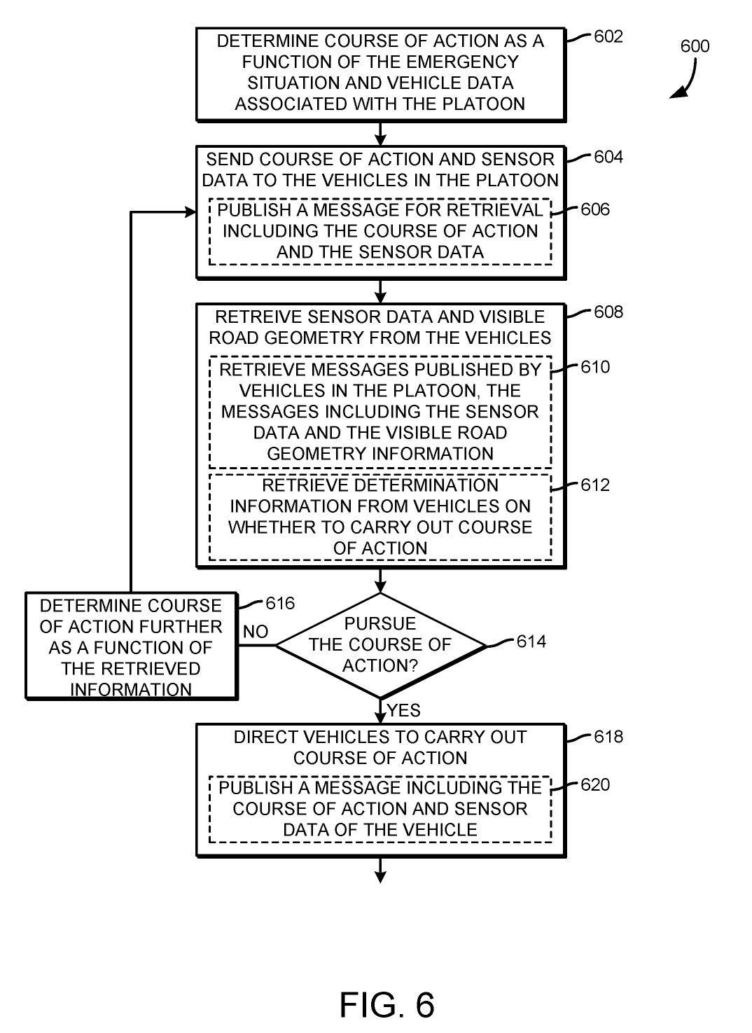

Referring now to FIG. 6, the vehicle control system 104, in operation, may perform a method 600 for determining a course of action to take by a platoon of vehicles during an emergency situation. In this example, assume that the vehicle control system 104 is of the leader vehicle in the platoon formed relative to the method 500. As shown, method 600 begins in block 602, in which the vehicle control system 104 determines a course of action as a function of the emergency situation and data shared between the vehicles of the platoon. For example, the course of action may be to reduce speed and assume a single file position according to rank of operational sensors. The course of action may include specific information for each vehicle to follow. In block 604, the vehicle control system 104 sends the course of action and sensor data of the platoon vehicles. For example, to do so, the vehicle control system 104 may include such information in the payload of a MQTT message, and, in block 606, publish the message for retrieval. In response, the vehicles in the platoon may retrieve the proposed course of action and make a local decision as to whether to carry out the action (e.g., based on sensor data and current state of the vehicle). The vehicles may publish information including sensor data and visible road geometry.

In block 608, the vehicle control system 104 retrieves sensor data and visible road geometry from the vehicles. In particular, in block 610, the vehicle control system 104 retrieves messages published by each vehicle in the platoon that include such information. In block 612, the vehicle control system 104 also retrieves determination information from the vehicles indicative of whether to carry out the course of action.

In block 614, the vehicle control system 104 determines whether to pursue the course of action. For instance, to do so, the vehicle control system 104 may evaluate the determination information obtained from each of the vehicles in the platoon. If a quorum of the vehicles in the platoon (e.g., a specified amount of vehicles) agrees on the course of action, the leader may determine to pursue the course of action. However, if a quorum is not reached, then in block 616, the vehicle control system 104 determines another or a modified course of action. For example, the vehicle control system 104 may evaluate a new course of action based on the sensor data and visible road geometry information obtained from the other vehicles after sending the previous course of action.

Otherwise, if a quorum of vehicles agrees on the course of action, then, in block 618, the vehicle control system 104 directs the vehicles to carry out the course of action. For instance, to do so, in block 620, the vehicle control system 104 publishes a message instructing the vehicle to follow the course of action.

The vehicles in the platoon may continue to cooperate with one another to safely navigate through the emergency situation. Further, the platoon may dissolve in response to a variety of events, such as when all vehicles in the platoon have reached a complete stop, a manual override from one or more operators of the vehicles in the platoon, a notification from the alert system that the emergency situation is no longer present, sensors in all vehicles of the platoon becoming operational for a period of time exceeding a threshold, and the like.

### EXAMPLES

Illustrative examples of the technologies disclosed herein are provided below. An embodiment of the technologies may include any one or more, and any combination of, the examples described below.

Example 1 includes a vehicle control system, comprising a plurality of sensors; and a compute engine to detect a trigger indicative of an emergency situation; form, in response to the trigger, a platoon with one or more vehicles within a predefined radius of the vehicle control system; and establish communications with the one or more vehicles in the platoon to determine a course of action to perform during the emergency situation.

Example 2 includes the subject matter of Example 1, and wherein to detect the trigger indicative of the emergency situation comprises to receive a notification indicative of the emergency situation from an alert source.

Example 3 includes the subject matter of any of Examples 1 and 2, and wherein to detect the trigger indicative of the emergency situation comprises to detect a malfunction in one or more of the plurality of sensors.

Example 4 includes the subject matter of any of Examples 1-3, and wherein to detect the trigger indicative of the emergency situation further comprises to notify an alert source of the detected malfunction.

Example 5 includes the subject matter of any of Examples 1-4, and wherein to form the platoon with one or more vehicles within the predefined radius comprises to detect the one or more vehicles within the predefined radius; and establish an ad-hoc network inclusive of the detected one or more vehicles.

Example 6 includes the subject matter of any of Examples 1-5, and wherein to form the platoon with one or more vehicles within the predefined radius comprises to elect a leader within the one or more vehicles.

Example 7 includes the subject matter of any of Examples 1-6, and wherein to elect the leader within the one or more vehicles comprises to elect the leader via a consensus protocol.

Example 8 includes the subject matter of any of Examples 1-7, and wherein to establish the communications with the one or more vehicles in the platoon comprises to subscribe to a messaging service from the one or more vehicles in the platoon.

Example 9 includes the subject matter of any of Examples 1-8, and wherein the compute engine is further to determine a course of action as a function of the emergency situation; send the course of action and data from the plurality of sensors to the one or more vehicles in the platoon.

Example 10 includes the subject matter of any of Examples 1-9, and wherein the compute engine is further to retrieve, from each of the one or more vehicles in the platoon, sensor data and visible road geometry data.

Example 11 includes the subject matter of any of Examples 1-10, and wherein the compute engine is further to retrieve, from the one or more vehicles in the platoon, a determination indicative of whether to carry out the course of action.

Example 12 includes the subject matter of any of Examples 1-11, and wherein the compute engine is further to, in response to a determination to carry out the course of action, direct the one or more vehicles to carry out the course of action.

Example 13 includes the subject matter of any of Examples 1-12, and wherein the compute engine is further to retrieve a course of action from one of the one or more vehicles in the platoon; determine, as a function of data from the plurality of sensors and on observed visible road geometry, whether to carry out the course of action; and send the determination to the one or more vehicles in the platoon.

Example 14 includes a computer-implemented method comprising detecting, by execution of one or more processors in a vehicle control system, a trigger indicative of an emergency situation; forming, in response to the trigger, a platoon with one or more vehicles within a predefined radius of the vehicle control system; and establishing communications with the one or more vehicles in the platoon to determine a course of action to perform during the emergency situation.

Example 15 includes the subject matter of Example 14, and wherein detecting the trigger indicative of the emergency situation comprises receiving a notification indicative of the emergency situation from an alert source.

Example 16 includes the subject matter of any of Examples 14 and 15, and wherein detecting the trigger indicative of the emergency situation comprises detecting a malfunction in one or more of a plurality of sensors in the vehicle control system; and notifying an alert source of the detected malfunction.

Example 17 includes the subject matter of any of Examples 14-16, and wherein forming the platoon with one or more vehicles within the predefined radius comprises detecting the one or more vehicles within the predefined radius; establishing an ad-hoc network inclusive of the detected one or more vehicles; and electing a leader within the one or more vehicles via a consensus protocol.

Example 18 includes the subject matter of any of Examples 14-17, and wherein establishing the communications with the one or more vehicles in the platoon comprises subscribing to a messaging service from the one or more vehicles in the platoon.

Example 19 includes the subject matter of any of Examples 14-18, and further including determining a course of action as a function of the emergency situation; sending the course of action and data from a plurality of sensors to the one or more vehicles in the platoon; retrieving, from each of the one or more vehicles in the platoon, sensor data and visible road geometry data; retrieving, from the one or more vehicles in the platoon, a determination indicative of whether to carry out the course of action; in response to a determination to carry out the course of action, directing the one or more vehicles to carry out the course of action.

Example 20 includes one or more machine-readable storage media comprising a plurality of instructions, which, when executed, cause a vehicle control system to detect a trigger indicative of an emergency situation; form, in response to the trigger, a platoon with one or more vehicles within a predefined radius of the vehicle control system; and establish communications with the one or more vehicles in the platoon to determine a course of action to perform during the emergency situation.

Example 21 includes the subject matter of Example 20, and wherein to detect the trigger indicative of the emergency situation comprises to receive a notification indicative of the emergency situation from an alert source.

Example 22 includes the subject matter of any of Examples 20 and 21, and wherein to detect the trigger indicative of the emergency situation comprises to detect a malfunction in one or more of a plurality of sensors in the vehicle control system.

Example 23 includes the subject matter of any of Examples 20-22, and wherein to detect the trigger indicative of the emergency situation further comprises to notify an alert source of the detected malfunction.

Example 24 includes the subject matter of any of Examples 20-23, and wherein to form the platoon with one or more vehicles within the predefined radius comprises to detect the one or more vehicles within the predefined radius; and establish an ad-hoc network inclusive of the detected one or more vehicles.

Example 25 includes a vehicle control system comprising means for detecting a trigger indicative of an emergency situation; means for forming, in response to the trigger, a platoon with one or more vehicles within a predefined radius of the vehicle control system; and means for establishing communications with the one or more vehicles in the platoon to determine a course of action to perform during the emergency situation.

1. A vehicle control system, comprising:
a plurality of sensors; and
a compute engine to:
detect a trigger indicative of an emergency situation;
form, in response to the trigger, a platoon with one or more vehicles within a predefined radius of the vehicle control system; and
establish communications with the one or more vehicles in the platoon to determine a course of action to perform during the emergency situation.

2. The vehicle control system of claim 1, wherein to detect the trigger indicative of the emergency situation comprises to receive a notification indicative of the emergency situation from an alert source.

3. The vehicle control system of claim 1, wherein to detect the trigger indicative of the emergency situation comprises to detect a malfunction in one or more of the plurality of sensors.

4. The vehicle control system of claim 3, wherein to detect the trigger indicative of the emergency situation further comprises to notify an alert source of the detected malfunction.

5. The vehicle control system of claim 1, wherein to form the platoon with one or more vehicles within the predefined radius comprises to:
detect the one or more vehicles within the predefined radius; and
establish an ad-hoc network inclusive of the detected one or more vehicles.

6. The vehicle control system of claim 1, wherein to form the platoon with one or more vehicles within the predefined radius comprises to elect a leader within the one or more vehicles.

7. The vehicle control system of claim 6, wherein to elect the leader within the one or more vehicles comprises to elect the leader via a consensus protocol.

8. The vehicle control system of claim 1, wherein to establish the communications with the one or more vehicles in the platoon comprises to subscribe to a messaging service from the one or more vehicles in the platoon.

9. The vehicle control system of claim 1, wherein the compute engine is further to:
determine a course of action as a function of the emergency situation;
send the course of action and data from the plurality of sensors to the one or more vehicles in the platoon.

10. The vehicle control system of claim 9, wherein the compute engine is further to retrieve, from each of the one or more vehicles in the platoon, sensor data and visible road geometry data.

11. The vehicle control system of claim 10, wherein the compute engine is further to retrieve, from the one or more vehicles in the platoon, a determination indicative of whether to carry out the course of action.

12. The vehicle control system of claim 11, wherein the compute engine is further to, in response to a determination to carry out the course of action, direct the one or more vehicles to carry out the course of action.

13. The vehicle control system of claim 1, wherein the compute engine is further to:
retrieve a course of action from one of the one or more vehicles in the platoon;
determine, as a function of data from the plurality of sensors and on observed visible road geometry, whether to carry out the course of action; and
send the determination to the one or more vehicles in the platoon.

14. A computer-implemented method comprising:
detecting, by execution of one or more processors in a vehicle control system, a trigger indicative of an emergency situation;
forming, in response to the trigger, a platoon with one or more vehicles within a predefined radius of the vehicle control system; and
establishing communications with the one or more vehicles in the platoon to determine a course of action to perform during the emergency situation.

15. The computer-implemented method of claim 14, wherein detecting the trigger indicative of the emergency situation comprises receiving a notification indicative of the emergency situation from an alert source.

16. The computer-implemented method of claim 14, wherein detecting the trigger indicative of the emergency situation comprises:
detecting a malfunction in one or more of a plurality of sensors in the vehicle control system; and
notifying an alert source of the detected malfunction.

17. The computer-implemented method of claim 14, wherein forming the platoon with one or more vehicles within the predefined radius comprises:
detecting the one or more vehicles within the predefined radius;
establishing an ad-hoc network inclusive of the detected one or more vehicles; and
electing a leader within the one or more vehicles via a consensus protocol.

18. The computer-implemented method of claim 14, wherein establishing the communications with the one or more vehicles in the platoon comprises subscribing to a messaging service from the one or more vehicles in the platoon.

19. The computer-implemented method of claim 14, further comprising:
determining a course of action as a function of the emergency situation;
sending the course of action and data from a plurality of sensors to the one or more vehicles in the platoon;
retrieving, from each of the one or more vehicles in the platoon, sensor data and visible road geometry data;
retrieving, from the one or more vehicles in the platoon, a determination indicative of whether to carry out the course of action;
in response to a determination to carry out the course of action, directing the one or more vehicles to carry out the course of action.

20. One or more machine-readable storage media comprising a plurality of instructions, which, when executed, cause a vehicle control system to:
detect a trigger indicative of an emergency situation;
form, in response to the trigger, a platoon with one or more vehicles within a predefined radius of the vehicle control system; and
establish communications with the one or more vehicles in the platoon to determine a course of action to perform during the emergency situation.

21. The one or more machine-readable storage media of claim 20, wherein to detect the trigger indicative of the emergency situation comprises to receive a notification indicative of the emergency situation from an alert source.

22. The one or more machine-readable storage media of claim 20, wherein to detect the trigger indicative of the emergency situation comprises to detect a malfunction in one or more of a plurality of sensors in the vehicle control system.

23. The one or more machine-readable storage media of claim 22, wherein to detect the trigger indicative of the emergency situation further comprises to notify an alert source of the detected malfunction.

24. The one or more machine-readable storage media of claim 20, wherein to form the platoon with one or more vehicles within the predefined radius comprises to:
detect the one or more vehicles within the predefined radius; and
establish an ad-hoc network inclusive of the detected one or more vehicles.

25. A vehicle control system comprising:
means for detecting a trigger indicative of an emergency situation;
means for forming, in response to the trigger, a platoon with one or more vehicles within a predefined radius of the vehicle control system; and
means for establishing communications with the one or more vehicles in the platoon to determine a course of action to perform during the emergency situation.
